(19) United States
(12) Patent Application Publication
(10) Pub. No.: US 2015/0034605 A1
(43) Pub. Date: Feb. 5, 2015

(54) HIGH FRACTURE TOUGHNESS WELDS IN THICK WORKPIECES

(71) Applicant: Lincoln Global, Inc., City of Industry, CA (US)

(72) Inventors: James M. Keegan, Chardon, OH (US); Radhika Panday, Mayfield Village, OH (US); Jonathan S. Ogborn, Concord Twp., OH (US); Badri K. Narayanan, Mayfiled Heights, OH (US)

(21) Appl. No.: 14/324,320

(22) Filed: Jul. 7, 2014

Related U.S. Application Data
(60) Provisional application No. 61/843,827, filed on Jul. 8, 2013.

(51) Int. Cl. B23K 9/00; B23K 35/30; B23K 9/173

(52) U.S. Cl. CPC B23K 9/0026; B23K 9/173; B23K 35/3073; B23K 35/3066
USPC 219/74; 219/145.22; 219/137 WM

(57) ABSTRACT

Embodiments of flux cored welding electrodes and methods of use thereof are disclosed. The flux cored welding electrodes limit brittleness of flux cored arc welds, particularly in thick weld deposits. Limiting brittleness in thick (e.g., from about 1″ to about 6″) flux cored arc welds is achieved by utilizing flux cored welding electrodes having chemical compositions that reduce (as compared to presently marketed electrodes) or altogether eliminate niobium and vanadium from their chemical compositions.

### CROSS-REFERENCE TO RELATED APPLICATION

This application claims priority to and the benefit of U.S. Provisional Patent Application Ser. No. 61/843,827, entitled “HIGH FRACTURE TOUGHNESS WELDS IN THICK WORK PIECES” and filed Jul. 8, 2013, the entire disclosure of which is incorporated herein by reference.

### FIELD

The disclosure is directed to a welding composition useful for thick welding applications, for example, 1″ to 6″ thick welds.

### BACKGROUND

The fabrication of structures made from welding together tubular members presents a difficult challenge. In particular, welds at T-, Y-, and K-connections require thick welds that generally require several passes to provide a strong connection (i.e., having good weld metal “toughness”) that can securely bear a stressful load. This challenge is typically present in the fabrication of offshore structures.

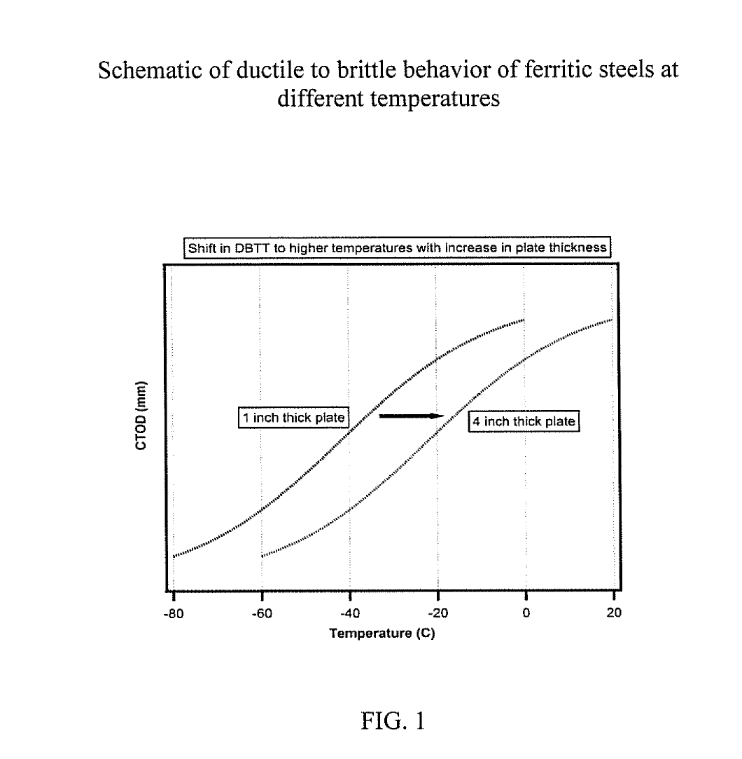

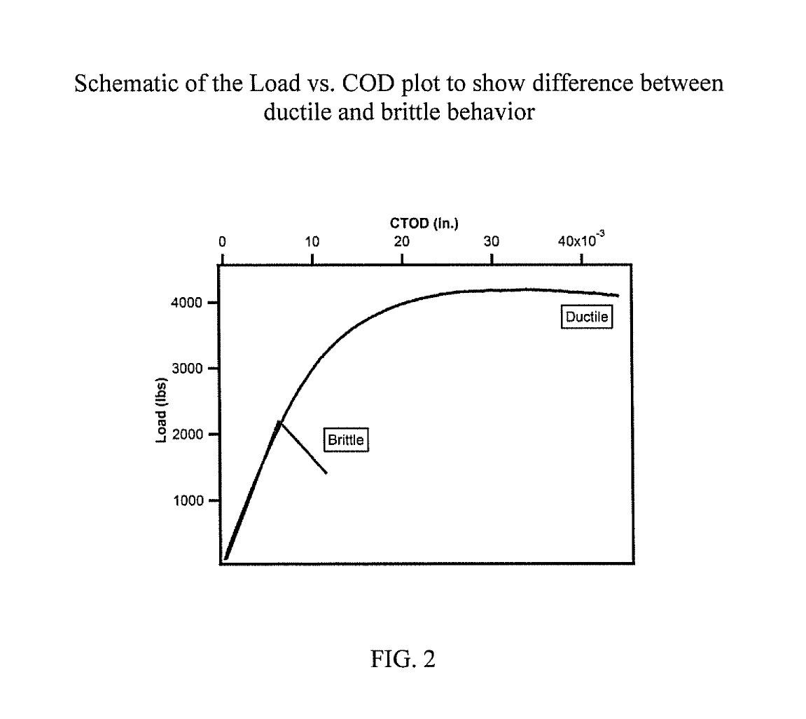

Historically, the toughness of a weld) was evaluated by using a Charpy V-Notch Test (“Charpy V”). The Charpy V involves making a weld in a sample that is typically 10 mm by 10 mm, machining a notch in the weld, and using a pendulum impact tester to force the sample to break at the notch. The energy absorbed in breaking the sample is calculated by measuring the height of the pendulum after impact. For thick (e.g., about 1″ to about 6″) weld deposits, the Charpy V may provide insufficient data related to weld integrity, as a 10 mm by 10 mm sample is too narrow to reflect the quality of such thick weld deposits, which mostly require several passes and tend to show brittle behavior in such thick sections (see FIGS. 1 and 2). Several weld passes provide a corresponding number of heating and cooling cycles on each pass of weld deposit. The fracture toughness of the material as measured using a crack tip opening displacement (“CTOD”) test is more discerning in the determination of a material's ductile or brittle behavior.

Ferritic steels found in offshore structures typically show a variation from ductile behavior at high temperatures to brittle behavior at low temperatures with the transition from ductile to brittle being dramatic at a certain temperature (i.e., transition temperature). This transition temperature can be a parameter in determining the material's resistance to brittle failure. The transition temperature of a material is important because structural specifications in general have tended to require that the material (whether base or weld) show ductile behavior at a particular temperature defined by the requirements of the application. For example, structures to be used in an Arctic region typically require −60° C. to be the test temperature to determine ductile behavior of the structure, including the weld.

### SUMMARY

In a first exemplary embodiment, the present disclosure is directed to a flux cored welding electrode for producing high fracture toughness welds in thick, iron-based workpieces using a flux cored arc welding process. The flux cored welding electrode comprises a particulate core and a metal sheath surrounding the particulate core. The chemical composition of the metal sheath and the chemical composition of the particulate core are selected so that the weld deposit composition produced by the flux cored welding electrode comprises iron and no more than about 0.007% by weight niobium and no more than about 0.009% by weight vanadium. The weld process is capable of creating a weld deposit possessing a fracture toughness as measured by crack tip opening displacement of at least about 0.35 mm at a temperature of about 0° C. and a ductile mode of fracture in weld joints that possess a thickness ranging from about 1″ to about 6″.

In a second exemplary embodiment, the present disclosure is directed to a method of connecting a first piece of steel to a second piece of steel using a welding process. Each of the first and second pieces of steel have a thickness ranging from about 12 mm to about 160 mm. The method comprises forming a weld deposit using a flux cored arc welding process and having at least 10 weld passes. The weld deposit connects the first and second pieces of steel. The weld deposit has a thickness of from about 1″ to about 6″. The chemical composition of the metal sheath and the chemical composition of the particulate core are selected so that the weld deposit composition produced by the flux cored welding electrode comprises no more than about 0.007% by weight niobium and no more than about 0.009% by weight vanadium. The weld process creates a weld deposit possessing a fracture toughness as measured by crack tip opening displacement of at least about 0.35 mm at a temperature of about 0° C. and a ductile mode of fracture in weld joints that possess a thickness ranging from about 1″ to about 6″.

### DETAILED DESCRIPTION OF THE DRAWINGS

This invention may be more readily understood by reference to the following drawings wherein:

FIG. 1 is a schematic illustrating the tendency of a ferritic steel to exhibit ductile and/or brittle behavior as a function of temperature;

FIG. 2 is a schematic illustrating how the ductile and/or brittle nature of a steel affect its fracture toughness, as measured using a crack tip opening displacement test;

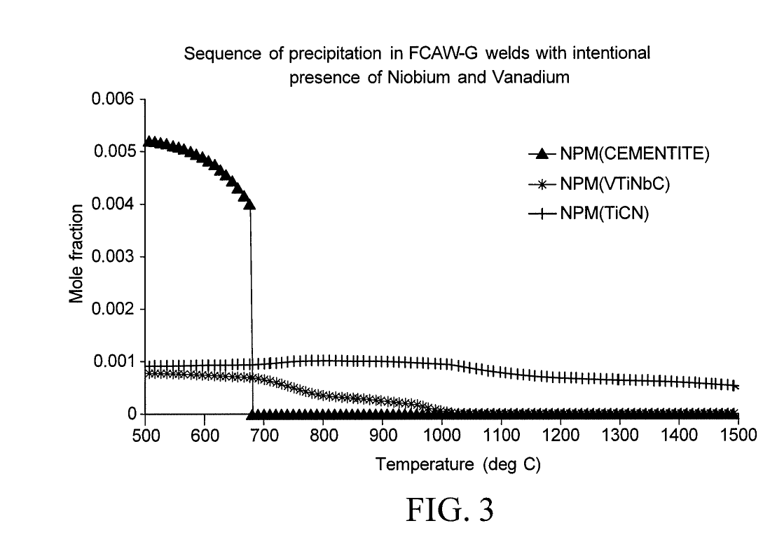

Fig. FIG. 3 illustrates the precipitation sequence of the precipitates that can form in welds deposited with a FCAW-G process as a function of temperature; and

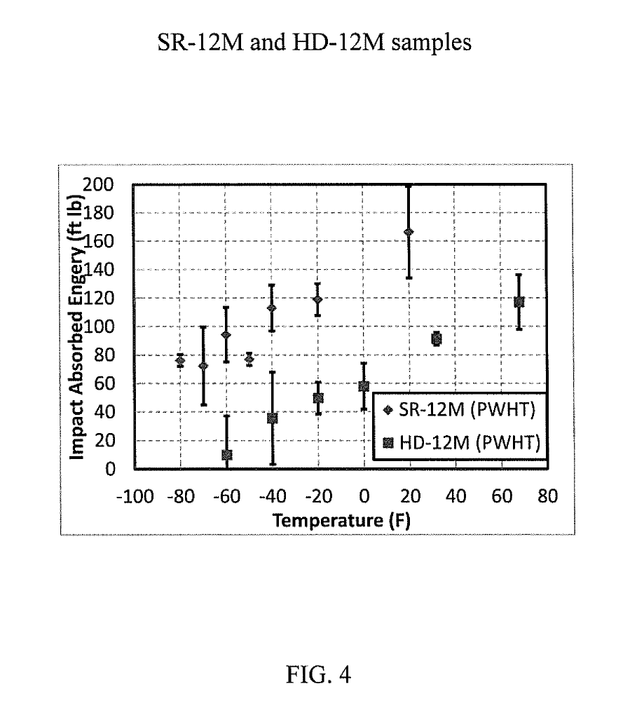

FIG. 4 illustrates the improved properties exhibited by welds made in accordance with this invention.

### DETAILED DESCRIPTION

While embodiments encompassing the general inventive concepts may take various forms, there is shown in the drawings and will hereinafter be described various embodiments with the understanding that the present disclosure is to be considered merely an exemplification and is not intended to be limited to the specific embodiments.

Unless defined otherwise, all technical and scientific terms used herein have the same meaning as commonly understood by one of ordinary skill in the art to which the disclosure belongs. In the drawings, the thickness of the lines, layers, and regions may be exaggerated for clarity. It is to be noted that like numbers found throughout the figures denote like elements. The terms “top,” “bottom,” “front,” “back,” “side,” “upper,” “under,” and the like are used herein for the purpose of explanation only. It will be understood that when an element such as a layer, region, area, or panel is referred to as being “on” another element, it can be directly on the other element or intervening elements may be present. If an element or layer is described as being “adjacent to” or “against” another element or layer, it is to be appreciated that that element or layer may be directly adjacent to or directly against that other element or layer, or intervening elements may be present. It will also be understood that when an element such as a layer or element is referred to as being “over” another element, it can be directly over the other element, or intervening elements may be present.

While weight percentages (and ranges thereof) of elements in a weld deposit are recited throughout the present disclosure, a person having skill in the art will readily recognize that the weight percentages of the elements do not necessarily recite weight percentages of elemental forms of the elements, but only the presence of the elements in all forms (elemental, within compositions, etc.) in the weld deposit.

The inventive flux cored welding electrode is formulated so that the weld deposit produced by this electrode (i.e., without material having been contributed from the workpieces being welded) has a composition as described herein. As appreciated in the art, the weld deposit composition of a welding electrode is the composition of the weld produced without contamination from any other source. It is normally different from the chemical composition of the weld metal obtained when the electrode is used to weld a workpiece, which weld metal can contain as much as 10%, 20%, 30% or even more of ingredients derived from the workpiece.

This disclosure is directed to a flux cored welding electrode for producing high fracture toughness complete welds in thick ferritic steel workpieces using a flux cored arc welding process. In this context, a “complete weld” will be understood to mean a weld whose thickness is at least 80% of the thickness of the workpiece being welded. Normally, the thickness of the weld will be at least 90% of the thickness of the workpiece. Even more typically, the thickness of the weld will be at least 100%, at least 110% or even more of the thickness of the workpiece.

Also, in this context, “thick” will be understood to mean that the portion of the workpiece where the weld is made has a thickness (minimum dimension) of at least about 1 inch (2.54 cm). Also, “thickness” in connection with hollow workpieces will be understood to refer to the thickness of the wall of the workpiece and not its overall thickness. In terms of minimum thickness, this invention finds particular applicability in welding ferritic steel workpieces at least 1 inch thick, as indicated above. In other embodiments, the workpieces can have a minimum thickness of 2 inches, 3 inches, 4 inches, 5 inches or more. In terms of maximum thickness, there is no practical maximum thickness. That is to say, the inventive welding process can be used to weld ferritic steel workpieces of any thickness that can be welded by any other arc welding process. As a practical matter, however, this maximum thickness will normally be no greater than about 8 inches, more typically no greater than about 7 inches or even 6 inches. The term “thickness,” as it pertains to the present disclosure, refers to the measurement of the weld deposit in a direction perpendicular to the weld surface.

In accordance with this invention, it has been discovered that welds made in this type of workpiece exhibit improved fracture toughness provided that the weld deposit composition produced by the welding electrode contains no more than about 0.007% by weight niobium and no more than about 0.009% by weight vanadium, with the combined amounts of niobium and vanadium in the weld deposit composition being no more than about 0.016% by weight. In this context, “weld deposit composition” will be understood to mean the composition produced when the welding electrode is melted and solidified without contamination from the metal workpiece being welded.

In a first exemplary embodiment, the present disclosure is directed to a flux cored welding electrode for producing high fracture toughness welds in thick, iron-based workpieces using a flux cored arc welding process. The flux cored welding electrode comprises a particulate core and a metal sheath surrounding the particulate core. The chemical composition of the metal sheath and the chemical composition of the particulate core are selected so that the weld deposit composition produced by the flux cored welding electrode comprises iron and no more than about 0.007% by weight niobium and no more than about 0.009% by weight vanadium. The weld process is capable of creating a weld deposit possessing a fracture toughness as measured by crack tip opening displacement of at least about 0.35 mm at a temperature of about 0° C. and a ductile mode of fracture in weld joints that possess a thickness ranging from about 1″ to about 6″.

In a second exemplary embodiment, the present disclosure is directed to a method of connecting a first piece of steel to a second piece of steel using a welding process. Each of the first and second pieces of steel have a thickness ranging from about 12 mm to about 160 mm. The method comprises forming a weld deposit using a flux cored arc welding process and having at least 10 weld passes. The weld deposit connects the first and second pieces of steel. The weld deposit has a thickness of from about 1″ to about 6″. The chemical composition of the metal sheath and the chemical composition of the particulate core are selected so that the weld deposit composition produced by the flux cored welding electrode comprises no more than about 0.007% by weight niobium and no more than about 0.009% by weight vanadium. The weld process creates a weld deposit possessing a fracture toughness as measured by crack tip opening displacement of at least about 0.35 mm at a temperature of about 0° C. and a ductile mode of fracture in weld joints that possess a thickness ranging from about 1″ to about 6″.

The present disclosure is related to the chemical composition of a flux cored welding electrode for thick weld applications. The embodiments of the present disclosure are particularly useful for fabrication of offshore structures, and more particularly offshore oil rigs. Offshore structures are typically fabricated of 516 grade 70 steel, which is a ferritic steel. The typical offshore structure is specified to have a 60-80 ksi yield strength utilizing steel pieces having thicknesses of about 12 mm to about 160 mm that are welded in several places, thereby forming an intricate steel structure.

Thick welds are necessary in several structural steel applications. For example, structural fabrication of offshore structures can be both beam-to-beam and beam-to-column, similar to terrestrial building erection. Offshore structures typically require several connections of tubular-shaped pieces. Tubular connections are typically classified as either T, Y, or K connections depending on the arrangement of the tubular-shaped pieces. T, Y, or K connections create joints that typically require multiple passes of weld metal to generate a connection that is structurally sound. The number of passes can vary, for example, from about 10 to about 100, including from about 20 to about 100, and including from about 30 to about 100. The multiple passes tend to generate complex thermal cycles experienced by the weld deposit due to repeated heating and cooling of the weld deposit by subsequent passes. This lends itself to microstructural modifications that are difficult to simulate in small sections, and are difficult to evaluate for defects generated during the overall welding process.

For all embodiments of the present disclosure, the weld metal is deposited with a flux cored electrode, which may take the form of a wire. The flux cored electrode provides a rutile (i.e., titanium dioxide) based flux with intentional additions of manganese, silicon, carbon, and molybdenum for alloying. Additions of titanium and magnesium may be provided by the flux cored electrode, which can provide deoxidation.

Arc welding is a type of welding in which the heat used for melting the metal being welded is derived from an electric arc. In general, there are two broad categories of arc welding, those in which the weld is formed entirely from the workpiece being welded (“autogenous” welding) and those in which a significant part of the weld is derived from a weld filler material (“non-autogenous” welding).

Arc welders typically take precautions to keep impurities out of the weld deposit. Two basic approaches are used in arc welding for avoiding contamination of the molten weld metal with atmospheric oxygen and/or nitrogen: using a shielding gas and using a flux. The two basic approaches can be combined if desired. When a shielding gas is used in autogenous welding, the process is normally referred to as gas tungsten arc welding (“GTAW”) or tungsten inert gas (“TIG”) welding, since the non-consumable electrode used is normally made from tungsten. When a shielding gas is used in non-autogenous welding, the process is normally referred to as gas metal arc welding (“GMAW”) or its subcategories metal inert gas (“MIG”) welding when the shielding gas is inert or metal active gas (“MAG”) welding when the shielding gas is reactive. While the other technique for preventing atmospheric contamination, i.e., using a flux, is not normally used in autogenous welding, the particular application may call for the combination of the two.

Three different approaches are used in non-autogenous welding for preventing atmospheric contamination with fluxes. In one approach, the flux is coated onto the surfaces of a separately supplied filler material. Manual metal arc welding (“MMA”) (also referred to as “stick” or shielded metal arc welding (“SMAW”)), in which the weld filler material in the form of a rod or stick is manually supplied to the welding site, is a good example of this approach.

In a second approach, referred to as submerged arc welding (“SAW”), atmospheric contamination is prevented by covering a seam to be welded with a substantial layer of the flux. A consumable electrode is moved through the flux is such a way that the arc struck between the electrode and the workpiece remains totally submerged in the flux. Heat from the welding arc melts the flux, thereby producing a molten flux layer which shields the weld metal from atmospheric contamination, prevents spatter and sparks, and suppresses the intense ultraviolet radiation and fumes normally produced during arc welding. The molten flux layer also becomes electrically conductive, thereby providing a current path between the workpiece and the electrode.

A third approach for preventing atmospheric contamination with fluxes in non-autogenous welding is known as flux cored welding (“FCAW”). In FCAW, a consumable electrode is used as the filler material. Such a consumable electrode is shaped in the form of a hollow tubular sheath, with the flux housed inside this sheath. Two different types of FCAW are used. In self-shielded FCAW (“FCAW-S”), which is sometimes referred to as “dual shield” welding, no shielding gas is used since the flux contains ingredients that generate the necessary shielding gas at welding temperatures. In gas-assisted FCAW (“FCAW-G”), a shielding gas is used. In certain embodiments, the methods disclosed herein utilize gas-assisted flux cored arc welding.

The embodiments of the flux cored welding electrode of the present disclosure can be welded while utilizing a shielding gas. In certain embodiments, the shielding gas comprises argon and carbon dioxide. In certain embodiments, the shielding gas comprises from about 60% to about 90% by volume argon and from about 10% to about 40% by volume carbon dioxide. In certain embodiments, the shielding gas comprises about 75% by volume argon and about 25% by volume carbon dioxide.

The embodiments of the present disclosure are formulated so that the weld metal deposited using an FCAW-G process can provide superior fracture toughness for thick welds (e.g., from about 1″ to about 6″ welds) in the as-welded condition (i.e., without additional heat treatment). While not wishing to be bound by theory, factors that are believed to promote superior weld metal toughness are a fine microstructure (e.g., acicular ferrite) and low oxygen content (e.g., oxygen concentration<about 600 ppm). Controlling these two factors tends to generate a weld metal that provides acceptable toughness in the as-welded condition (i.e., without or prior to heat treating). However, welds made in accordance with the present disclosure can be subjected to additional heat treatment for added relief from residual stresses in the weld, if desired.

To achieve good weld metal toughness in both as-welded and post welded heat treated conditions, it is desirable to minimize the presence of certain elements that have a high affinity for carbon and nitrogen. Carbon and nitrogen are interstitial elements in the weld deposit and are considered “fast-diffusers” due to the small atomic size of each element. Carbon and nitrogen have the ability to move within the weld deposit during post weld heat treatment. In certain embodiments, titanium is present to form carbides and nitrides.

For all embodiments of the present disclosure, the presence of niobium and vanadium is reduced or altogether eliminated in the flux cored welding electrode, and thereby in the weld deposit. Niobium and vanadium are two commonly found tramp elements that have a strong affinity for carbon and nitrogen. Typical concentrations of niobium and vanadium in a weld deposit that utilizes presently marketed products average about 0.016% by weight niobium, and about 0.025% by weight vanadium, with the combined amounts of niobium and vanadium typically averaging about 0.04% by weight.

The chemical composition of the metal sheath and the chemical composition of the particulate core are selected so that the weld deposit composition produced by the flux cored welding electrode has a niobium concentration of less than about 0.007% by weight of the weld deposit, including less than about 0.006% by weight of the weld deposit, including less than about 0.005% by weight of the weld deposit, including less than about 0.004% by weight of the weld deposit, including zero percent by weight of the weld deposit (i.e., free from niobium).

The chemical composition of the metal sheath and the chemical composition of the particulate core are selected so that the weld deposit composition produced by the flux cored welding electrode has a vanadium concentration of less than about 0.009% by weight of the weld deposit, including less than about 0.008% by weight of the weld deposit, including less than about 0.007% by weight of the weld deposit, including less than about 0.006% by weight of the weld deposit, including zero percent by weight of the weld deposit (i.e., free from vanadium).

The weld deposit composition may comprise no more than a combined 0.016% by weight niobium and vanadium, which includes no more than a combined 0.01% by weight niobium and vanadium. In particularly preferred embodiments, the weld deposit is free from niobium and vanadium.

There are three types of precipitates that can form in welds deposited with a FCAW-G process. FIG. 3 shows a plot of the precipitation sequence as a function of temperature. The first precipitate to form is titanium carbonitride (TiCN). This precipitate forms at very high temperatures and is expected to be completed at temperatures greater than 1500° C. The second precipitate to form is a complex carbide rich in vanadium, titanium, and niobium (“Nb/V precipitates”). The last precipitate to form is an iron carbide also known as cementite. The presence of niobium and vanadium stabilizes the formulation of the complex carbide. In welds that experience extensive reheating due to multiple passes being deposited one on top of another and that may also undergo post-weld heat treatment, the dissolution of cementite and reprecipitation and/or coarsening of complex carbide occurs.

Thus, Nb/V precipitates can affect the toughness of the weld in two ways. While not wishing to be bound by theory, Nb/V precipitates tend to have very low intrinsic toughness (i.e., brittle) compared to other compositions present in the weld deposit, which can lead to cracking due to the stresses present within the weld. Nb/V precipitates also tend to coarsen during post weld heat treatment which means they are not as effective in restricting the growth of ferritic grains during heat treatment. Coarser grains due to grain growth also affect weld toughness.

The aforementioned effects of Nb/V precipitates generally increase during the welding of thick sections, where Nb/V precipitates have more opportunity for growth during the welding due to repeated heating of earlier weld passes by subsequent weld passes as well as by the higher levels of residual stresses within thick sections. While thin weld sections tend to have free surfaces that help in relieving stress, thick weld sections (e.g., from about 1″ to about 6″ weld thickness) tend to inhibit stress relief creating tri-axial states of stress within the thick weld deposits. Tri-axial states of stress tend to inhibit plastic flow critical for ductility of the structure. As described herein, the embodiments of the present disclosure limit the presence of niobium and vanadium, which have been modeled thermodynamically and shown to cause precipitation of titanium carbonitrides and Nb/V precipitates. Embodiments of the present disclosure exhibit ductile behavior in both Charpy V Notch testing as well as crack tip open displacement (“CTOD”) testing, which are further described herein.

Certain embodiments of the flux cored welding electrode of the present disclosure may be made in a conventional way, such as by beginning with a flat metal strip that is initially formed first into a “U” shape, for example, as shown in Bernard, U.S. Pat. No. 2,785,285; Sjoman, U.S. Pat. No. 2,944,142; and Woods, U.S. Pat. No. 3,534,390. Flux, alloying elements, and/or other core fill materials in particulate form are then deposited into the “U” and the strip is closed into a tubular configuration by a series of forming rolls. Normally, the tube so formed is then drawn through a series of dies to reduce its cross-section to a final desired diameter, after which the electrode so formed is then coated with a suitable feeding lubricant, wound into a spool, and then packaged for shipment and use.

The metal sheath can be made from an alloy containing about 0.01% to about 0.1% by weight carbon, about 0.2% to about 0.6% by weight manganese, about 0.03% to about 0.1% by weight silicon, no more than about 0.02% by weight phosphorus, and no more than about 0.025% sulfur. Specific examples of such alloys are typically described in industry as fine grained, fully killed (aluminum or silicon killed) steels including SAE/AISI 1008 and 1010. These alloys are readily available, commercially, in strip form, which helps make manufacture of the embodiments of the flux cored electrodes simple and inexpensive.

The weld deposit composition produced by the inventive flux cored welding electrode comprises carbon. The presence of carbon in the weld composition increases the strength and hardenability of the weld deposit. Additionally, the presence of carbon in solid solution tends to suppress ferrite transformation in iron-based metals leading to finer acicular microstructure as opposed to a soft ferritic microstructure that tends to coarsen more rapidly than in the absence of carbon. In certain embodiments, the weld deposit composition comprises from about 0.02% by weight to about 0.09% by weight carbon, including from about 0.03% by weight to about 0.08% by weight carbon, and including from about 0.04% by weight to about 0.07% by weight carbon.

The weld deposit composition produced by inventive flux cored welding electrode comprises manganese. The presence of manganese in the weld refines the microstructure, increases the strength, and increases the hardenability of the weld deposit, and further deoxidizes the weld pool. In certain embodiments, the weld deposit composition comprises from about 1% by weight to about 2% by weight manganese, including from about 1.1% by weight to about 1.8% by weight manganese, and including from about 1.25% by weight to about 1.5% by weight manganese.

The weld deposit composition produced by inventive flux cored welding electrode comprises silicon. The presence of silicon in the weld composition helps deoxidize the weld pool and decrease the viscosity of the molten metal. In certain embodiments, the weld deposit composition comprises from about 0.2% by weight to about 0.9% by weight silicon, including from about 0.3% by weight to about 0.7% by weight silicon, and including from about 0.35% by weight to about 0.55% by weight silicon.

The weld deposit composition produced by inventive flux cored welding electrode comprises titanium. Titanium is typically added to help deoxidize the weld pool. In certain embodiments, the weld deposit composition comprises no more than about 0.15% by weight titanium, including from about 0.02% by weight to about 0.11% by weight titanium, and including from about 0.04% by weight to about 0.09% by weight titanium.

The weld deposit composition produced by the inventive flux cored welding electrode comprises boron. The presence of boron in the weld composition helps to refine the grain structure by promoting the formation of acieular ferrite in the weld deposit. In certain embodiments, the weld deposit composition comprises no more than about 0.01% by weight boron, including from about 0.0005% by weight to about 0.009% by weight boron, and including from about 0.003% by weight to about 0.008% by weight boron.

The weld deposit composition produced by the inventive flux cored welding electrode comprises nickel. The presence of nickel in the weld composition helps to increase strength of the weld and, in particular, improve the low temperature impact toughness of the weld deposit, In certain embodiments, the weld deposit composition comprises no more than about 2% by weight nickel, including no more than about 1.3% by weight nickel, and including from about 0.6% by weight to about 1.3% by weight nickel.

The weld deposit composition produced by the inventive flux cored welding electrode comprises molybdenum. The presence of molybdenum in the weld composition helps to increase the strength and hardenability of the weld deposit. In certain embodiments, the weld deposit composition comprises no more than about 0.8% by weight molybdenum, including no more than about 0.6% by weight molybdenum, and including no more than about 0.3% by weight molybdenum.

The weld deposit composition produced by the inventive flux cored welding electrode comprises iron. Iron generally makes up a majority of the weight percentage of the weld deposit (i.e., from about 90% to about 99% by weight iron). In certain embodiments, iron is present in the weld deposit composition at greater than about 90% by weight iron, including greater than about 93% by weight iron, including greater than about 95% by weight iron, including greater than about 97% by weight iron, and no more than about 99% by weight iron.

Other elements may be present in the weld deposit composition. The other elements, known as “trace impurities” or “tramps” may include sulfur, nitrogen, oxygen, aluminum, arsenic, calcium, cadmium, cobalt, chromium, copper, phosphorus, lead, antimony, tin, tantalum, tungsten, and zirconium. Trace impurities typically make up no more than 1% by weight, including no more than 0.8% by weight, including no more than 0.5% by weight, including no more than 0.2% by weight, including no more than 0.1% by weight, including no more than 0.08% by weight, including at least about 0.06% by weight of the weld deposit composition.

In certain embodiments, the particulate core of the disclosed flux cored welding electrode is made from ingredients that tend to have no or low affinity for carbon and nitrogen, as described herein. Exemplary embodiments of chemical compositions of weld deposits are shown in Table 1 below. Each individual limitation recited in Table 1 should be interpreted as individually interchangeable with, and able to be incorporated into, any embodiment of the present disclosure.

TABLE 1
Weld Deposit Composition, wt. %, with the balance of each embodiment being iron

| | Embodiment 1 | Embodiment 2 | Embodiment 3 | Embodiment 4 | Embodiment 5 | Embodiment 6 |
|---|---|---|---|---|---|---|
| C | 0.02-0.09 | 0.03-0.08 | 0.04-0.06 | 0.02-0.09 | 0.03-0.08 | 0.04-0.06 |
| Mn | 1.15-1.75 | 1.24-1.61 | 1.33-1.52 | 1.08-2.00 | 1.17-1.54 | 1.26-1.45 |
| Si | 0.21-0.90 | 0.30-0.63 | 0.38-0.55 | 0.28-0.90 | 0.33-0.51 | 0.37-0.46 |
| Nb | ≦0.015 | ≦0.0109 | ≦0.0071 | ≦0.015 | ≦0.0109 | ≦0.0071 |
| V | ≦0.0200 | ≦0.0161 | ≦0.0107 | ≦0.0200 | ≦0.0161 | ≦0.0107 |
| Ti | ≦0.1321 | 0.0219-0.1100 | 0.0439-0.0880 | 0.0100-0.1073 | 0.0262-0.0911 | 0.0424-0.0749 |
| B | ≦0.0100 | 0.0030-0.0090 | 0.0040-0.0080 | ≦0.0100 | 0.0005-0.0090 | 0.0036-0.0080 |
| Ni | ≦0.390 | ≦0.161 | ≦0.095 | 0.39-2.00 | 0.50-2.00 | 0.68-1.27 |
| Mo | ≦0.300 | ≦0.020 | 0.004-0.012 | ≦0.731 | ≦0.509 | ≦0.286 |
| Trace | ≦1 | ≦0.5 | ≦0.3 | ≦0.6 | ≦0.5 | ≦0.4 |
| impurities | | | | | | |
| (exemplary | | | | | | |
| trace | | | | | | |
| impurities | | | | | | |
| further | | | | | | |
| detailed | | | | | | |
| below) | | | | | | |
| S | 0.0028-0.0300 | 0.0042-0.0099 | 0.0056-0.0084 | ≦0.125 | ≦0.089 | ≦0.054 |
| N | ≦0.0110 | 0.0004-0.0089 | 0.0025-0.0068 | ≦0.0110 | 0.0004-0.0089 | 0.0025-0.0068 |
| O | 0.0307-0.0875 | 0.0402-0.0780 | 0.0496-0.0686 | 0.0307-0.0875 | 0.0402-0.0780 | 0.0496-0.0686 |
| Al | ≦0.0184 | ≦0.0146 | 0.0032-0.0108 | ≦0.0184 | ≦0.0146 | 0.0032-0.0108 |
| As | 0.0011-0.0033 | 0.0015-0.0029 | 0.0018-0.0026 | 0.0011-0.0033 | 0.0015-0.0029 | 0.0018-0.0026 |
| Ca | ≦0.0004 | ≦0.0003 | ≦0.0002 | ≦0.0004 | ≦0.0003 | ≦0.0002 |
| Cd | ≦0.002 | ≦0.002 | ≦0.002 | ≦0.002 | ≦0.002 | ≦0.002 |
| Co | ≦0.4000 | 0.0040-0.0063 | 0.0046-0.0057 | 0.0034-0.0069 | 0.0040-0.0063 | 0.0046-0.0057 |
| Cr | 0.0122-0.0861 | 0.0245-0.0738 | 0.0368-0.0615 | 0.0122-0.1000 | 0.0245-0.0738 | 0.0368-0.0615 |
| Cu | 0.0021-0.1089 | 0.0199-0.0911 | 0.0377-0.0733 | 0.0021-0.1089 | 0.0199-0.0911 | 0.0377-0.0733 |
| P | 0.0058-0.0180 | 0.0078-0.0160 | 0.0099-0.0139 | 0.0058-0.0180 | 0.0078-0.0160 | 0.0099-0.0139 |
| Pb | ≦0.001 | ≦0.001 | ≦0.001 | ≦0.001 | ≦0.001 | ≦0.001 |
| Sb | ≦0.001 | ≦0.001 | ≦0.001 | ≦0.001 | ≦0.001 | ≦0.001 |
| Sn | 0.0006-0.0053 | 0.0014-0.0045 | 0.0022-0.0037 | 0.0006-0.0053 | 0.0014-0.0045 | 0.0022-0.0037 |
| Ta | ≦0.003 | ≦0.003 | ≦0.003 | ≦0.003 | ≦0.003 | ≦0.003 |
| W | ≦0.0126 | ≦0.0100 | 0.0022-0.0074 | ≦0.0443 | ≦0.0377 | 0.0181-0.0312 |
| Zr | ≦0.002 | ≦0.001 | ≦0.0005 | ≦0.002 | ≦0.001 | ≦0.0005 |

The weld deposit may have an acicular ferrite structure. The weld deposit may have an oxygen content of less than about 600 ppm, including less than about 300 ppm, and including less than about 100 ppm.

As mentioned herein, the embodiments of the present disclosure are foreseen as being particularly applicable to the fabrication of offshore structures, which can be made of ferritic steel. Either the first workpiece, the second workpiece, or both the first and second workpiece are ferritic steel, which may be a 516 grade 70 steel. In certain embodiments, either the first iron-based workpiece, the second iron-based workpiece, or both the first and second iron-based workpieces are tubular-shaped (i.e., cylindrical) workpieces.

The CTOD test is becoming a more popular method to discriminate weld metal resistance to brittle behavior for thick (e.g., from about 1″ to about 6″) welds, particularly for offshore structures. The CTOD test is designed to evaluate material resistance to ductile crack propagation. The CTOD test involves introducing a crack in the region of interest (e.g., the weld) by controlled bending to mimic a defect that may be present in the weld or generated during fabrication. This crack is then loaded to failure by imposing a very well defined stress state to mimic Mode 1 type of loading (i.e., pure tensile).

For the CTOD test, the dimensions of the samples are also defined to impose a “plane-strain” condition to prevent any yielding of the free surfaces to artificially increase the toughness of the material. CTOD tests are typically done “full-thickness” of the weld joint, i.e., a plate that is about 100 mm thick will have a CTOD specimen that is about 100 mm thick. In comparison, the Charpy V utilizes a 10 mm by 10 mm sample, which only samples a relatively small portion of a weld joint.

The weld process is capable of creating a weld deposit possessing a fracture toughness as measured by crack tip opening displacement of at least about 0.35 mm at a temperature of about 0° C. and a ductile mode of fracture in weld joints that possess a thickness ranging from about 1″ to about 6″. The weld process may be capable of creating a weld deposit possessing a fracture toughness as measured by crack tip opening displacement of at least about 0.35 mm at a temperature of about −10° C. and a ductile mode of fracture in weld joints that possess a thickness ranging from about 1″ to about 6″. The weld process may be capable of creating a weld deposit possessing a fracture toughness as measured by crack tip opening displacement of at least about 0.25 mm at a temperature of about −20° C. and a ductile mode of fracture in weld joints that possess a thickness ranging from about 1″ to about 6″.

FIG. 4 compares impact absorbed energy at various temperatures for an embodiment as defined in the first and second exemplary embodiments. The SR-12M sample, which demonstrates improved impact absorbed energy as compared to the HD-12M sample, comprises from about 0.001% to about 0.005% by weight niobium, and from about 0.003% to about 0.007% by weight vanadium, and more specifically about 0.003% by weight niobium and about 0.005% by weight vanadium, and further specified in Embodiment 3 of Table 1.

Any patents referred to herein, are hereby incorporated herein by reference, whether or not specifically done so within the text of this disclosure.

To the extent that the terms “include,” “includes,” or “including” are used in the specification or the claims, they are intended to be inclusive in a manner similar to the term “comprising” as that term is interpreted when employed as a transitional word in a claim. Furthermore, to the extent that the term “or” is employed (e.g., A or B), it is intended to mean “A or B or both A and B.” When the applicants intend to indicate “only A or B but not both,” then the term “only A or B but not both” will be employed. Thus, use of the term “or” herein is the inclusive, and not the exclusive use. See Bryan A. Garner, A Dictionary of Modern Legal Usage 624 (2d ed. 1995). Also, to the extent that the terms “in” or “into” are used in the specification or the claims, it is intended to additionally mean “on” or “onto.” Furthermore, to the extent that the term “connect” is used in the specification or the claims, it is intended to mean not only “directly connected to,” but also “indirectly connected to” such as connected through another component or components. In the present disclosure, the words “a” or “an” are to be taken to include both the singular and the plural. Conversely, any reference to plural items shall, where appropriate, include the singular.

All ranges and parameters disclosed herein are understood to encompass any and all sub-ranges assumed and subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

The general inventive concepts have been illustrated, at least in part, by describing various exemplary embodiments thereof. While these exemplary embodiments have been described in considerable detail, it is not the Applicant's intent to restrict or in any way limit the scope of the appended claims to such detail. Furthermore, the various inventive concepts may be utilized in combination with one another (e.g., one or more of the first, second, third, fourth, etc. exemplary embodiments may be utilized in combination with each other). Additionally, any particular element recited as relating to a particularly disclosed embodiment should be interpreted as available for use with all disclosed embodiments, unless incorporation of the particular element would be contradictory to the express terms of the embodiment. Additional advantages and modifications will be readily apparent to those skilled in the art. Therefore, the disclosure, in its broader aspects, is not limited to the specific details presented therein, the representative apparatus, or the illustrative examples shown and described. Accordingly, departures may be made from such details without departing from the spirit or scope of the general inventive concepts.

1. A flux cored welding electrode for producing high fracture toughness welds in thick workpieces, the flux cored welding electrode comprising a particulate core and a metal sheath surrounding the particulate core, wherein the chemical composition of the metal sheath and the chemical composition of the particulate core are selected so that the weld deposit composition produced by the flux cored welding electrode comprises: ≦about 0.007% by weight niobium and≦about 0.009% by weight vanadium.

2. The flux cored welding electrode of claim 1, wherein the weld deposit composition further comprises: 0.02-0.09% by weight carbon, 1-2% by weight manganese, 0.2-0.9% by weight silicon, ≦0.007% by weight niobium, ≦0.009% by weight vanadium, ≦0.15% by weight titanium, ≦0.01% by weight boron, ≦2% by weight nickel, ≦0.8% by weight molybdenum.

3. The flux cored welding electrode of claim 1, wherein the weld deposit composition further comprises: 0.03-0.08% by weight carbon, 1.1-1.8% by weight manganese, 0.3-0.7% by weight silicon, ≦0.007% by weight niobium, ≦0.009% by weight vanadium, 0.02-0.11% by weight titanium, 0.0005-0.009% by weight boron, ≦1.3% by weight nickel, ≦0.6% by weight molybdenum.

4. The flux cored welding electrode of claim 1, wherein the weld deposit composition further comprises: 0.04-0.07% by weight carbon, 1.25-1.5% by weight manganese, 0.35-0.55% by weight silicon, ≦0.007% by weight niobium, ≦0.009% by weight vanadium, 0.04-0.09% by weight titanium, 0,003-0.008% by weight boron, 0.6-1.3% by weight nickel, ≦0.3% by weight molybdenum.

5. The flux cored welding electrode of claim 1, wherein the weld deposit composition is free from niobium.

6. The flux cored welding electrode of claim 1, wherein the weld deposit composition is free from vanadium.

7. The flux cored welding electrode of claim 1, wherein the weld deposit composition is free from niobium and vanadium.

8. The flux cored welding electrode of claim 1, wherein the weld deposit composition comprises no more than a combined 0.016% by weight niobium and vanadium.

9. The flux cored welding electrode of claim 1, wherein the weld deposit composition comprises no more than a combined 0,01% by weight niobium and vanadium.

10. A method of connecting a first iron-based workpiece to a second iron-based workpiece using a welding process, each of the first and second iron-based workpieces having a thickness ranging from 12 mm to 160 mm, the method comprising:
forming a weld deposit using a flux cored arc welding process and having at least 10 weld passes, the weld deposit connecting the first and second iron-based workpieces;
wherein the weld deposit has a thickness of from about 1″ to about 6″; and
wherein the chemical composition of the metal sheath and the chemical composition of the particulate core are selected so that the weld deposit composition produced by the flux cored welding electrode comprises: ≦about 0.007% by weight niobium, ≦about 0.009% by weight vanadium and wherein the weld deposit has a fracture toughness as measured by crack tip opening displacement of at least about 0.35 mm at a temperature of about 0° C. and a ductile mode of fracture.

11. The method of claim 10, wherein the weld deposit composition further comprises 0.03-0.08% by weight carbon, 1.1-1.8% by weight manganese, 0.3-0.7% by weight silicon, ≦0.007% by weight niobium, ≦0.009% by weight vanadium, 0.02-0.11% by weight titanium, 0.0005-0.009% by weight boron, ≦1.3% by weight nickel, and ≦0.6% by weight molybdenum.

12. The method of claim 10, wherein the weld deposit composition is free of niobium.

13. The method of claim 10, wherein the weld deposit composition is free from vanadium.

14. he method of claim 10, wherein the weld deposit composition is free from niobium and vanadium.

15. The method of claim 10, wherein the weld deposit has a thickness ranging from about 2″ to about 5″.

16. The method of claim 10, wherein the weld deposit has a thickness ranging from about 3.5″ to about 4.5″.

17. The method of claim 10, wherein the first and second iron-based workpieces are ferritic steel.

18. The method of claim 10, wherein the first and second iron-based workpieces are 516 grade 70 steel.

19. The method of claim 10, wherein the weld deposit has an acicular ferrite structure.

20. The method of claim 10, wherein the weld deposit has an oxygen content of less than 600 ppm.

21. The method of claim 10, wherein the forming further utilizes a shielding gas.

22. The method of claim 21, wherein the shielding gas comprises from about 60% to about 90% by volume argon, and from about 10% to about 40% by volume carbon dioxide.
